(19) United States
(12) Patent Application Publication
(10) Pub. No.: US 2013/0038116 A1
(43) Pub. Date: Feb. 14, 2013

(54) Ceramic Balance Weight

(71) Applicant: Erika Fischer, Weilheim/Teck (DE)

(72) Inventor: Erika Fischer, Weilheim/Teck (DE)

(21) Appl. No.: 13/586,924

(22) Filed: Aug. 16, 2012

(30) Foreign Application Priority Data
Feb. 20, 2010 (DE) 10 2010 008 657.6

(51) Int. Cl. F16F 15/32; F16F 15/34

(52) U.S. Cl. 301/5.21

(57) ABSTRACT

The wheel weight according to the invention (5) consists of a body (7) consisting of ceramics. It is provided with means for fastening to a rim (3) with material fit and/or positive fit. The body (7) has a cross section that decreases along a prescribed direction, such as the direction normal to its upper surface (9). The ceramic body can have a high specific weight of two or more g/cm³ for example.

The invention relates to a wheel weight for installation on a motor vehicle wheel for balancing same.

It is well known to attach wheel weights of suitable mass at selected locations of the rims to eliminate balance errors and thereby ultimately bring the rotational axis and the center of gravity into accordance. Lead weights, which are attached to the rim with a suitable adhesive means, such as an adhesive tape or also mechanical fastening means, such as clamps or the like, are usually used for this.

The connection must necessarily be detachable, because the balance error of a motor vehicle wheel is mainly attributable to a nonuniformity of the tire that can hardly be avoided. The tire must be rebalanced after a tire change. It must therefore be possible to detach the wheel weights without damaging them. On the other hand, it should be possible to connect the wheel weights to the rim in an easy manner and they must be held there permanently so that they are not lost during the drive.

The loss of one wheel weight results not only in immediate imbalance of the wheel but can also pose a danger to passengers. Ejected wheel weights can furthermore damage vehicles. But ultimately, lost wheel weights also constitute an environmental hazard because they consist of lead.

Particularly out of the latter considerations, DE69829751T2 proposes that wheel weights be made of glass. The relevant glass body of the wheel weight has a rounded shape on all sides. It can be fastened to the rim with a clamp or even an adhesive layer.

In comparison to lead weights, these wheel weights consisting of glass have a smaller environmental pollution effect if they inadvertently detach from the rim. On the other hand, the wheel weights have relatively larger dimensions because of the lower density of glass. But glass weights, unlike lead weights, cannot be easily shaped to differently shaped rim surfaces. The fastening of glass weights to the rim is at least difficult. These circumstances complicate their use.

Proceeding from the above, it is the object of the invention to provide an improved alternative to lead wheel weights.

This object is achieved with the wheel weight according to claim 1.

The wheel weight according to the invention consists of ceramics.

Ceramics are largely inert and nonpoisonous. Inadvertently lost wheel weights thus pose no harm to the environment. Ceramic weights can be configured much smaller than glass weights if a ceramic of adequately high density is chosen. This will increase the acceptance of wheel weights not made of lead. Because of their naturally rough surfaces, ceramics can also be painted easily and thus be provided in the color of the rim.

Moreover, wheel weights made of ceramics can be manufactured in series with very well defined shape. Unlike glass weights, whose surfaces have no precise geometric shape due to manufacture in the melting process, ceramic bodies can be provided with well defined surface shapes through pressing and sintering.

The manufacture of wheel weights made of ceramics represents a low-cost alternative to wheel weights made of lead. It is furthermore possible to provide ceramic weights having low weight tolerance using technically simple means. Observation of the desired weight with narrow tolerance is already possible before or after sintering without individual calibration of the separate wheel weights. Even high tolerance requirements can be met, e.g. by calibrating the wheel weights with respect to weight before and after sintering. For example, the green compacts obtained by pressing can be calibrated and then sintered. Alternatively, a weight calibration can be performed after sintering, e.g. by grinding.

The ceramic weights are preferably provided as sintered ceramics, for example as oxide ceramics. The use of reaction ceramics is possible. Preferably, aluminum-oxide ceramics will be used here. Other oxides, like zirconium oxide, can be included to improve mechanical properties. Non-oxide ceramic materials like SiN or SiC can also be used to manufacture the ceramic weights. Furthermore, mixed oxides, feldspar ceramics as well as ceramic materials of the groups C221 to C779 mullites, steatites, cordierites, fosterites, aluminum silicates or other general ceramic substances or

mixtures thereof can be used. The given ceramic materials can be used as homogeneous materials or material mixtures with at least two of the abovementioned materials. Two or more of the abovementioned materials can also be combined into one nonhomogenous ceramic body. E.g. a core of another (ceramic) material can be embodied in one ceramic body made of a first material.

It is possible to produce the ceramic body out of a highly compressed ceramics. To this end, the starting body consisting of the appropriate powdered metal oxides can be pressed with high pressure, such as isostatically, before sintering, ceramic densities of up to 6 g/cm³ and above thereby being attainable. At the same time, the ceramic bodies can be provided with a low weight tolerance by means of pressing cycles carried out with appropriate precision. In addition, the ceramic bodies can also be calibrated with regard to weight by corresponding stripping measures, such as grinding, preferably before sintering but possibly also afterwards. To this end, one or more special parts can be provided on the ceramic body, e.g. pegs, burls or projections, that can be partially or completely ground off for calibration.

To increase the specific density of the ceramic body, raised isostatically applied pressing pressure, as mentioned, can be used. Independently thereof, it is also possible to help the ceramic body attain an increased weight by means of one or more imbedded heavy particles. E.g. the ceramic body can be provided with a metallic or non-metallic inlay (e.g. made of a feldspar ceramic or barite ceramic). The ceramic can also contain heavy metal salts, such as barium compounds, especially barium salts, e.g. barite, in compact or dispersed form. E.g. the ceramic present on the surface can consist of a visually appealing material or material chosen for its chemical or mechanical resistance and form a sheath. Internal parts of the ceramic weight are protected by the sheath and can be chosen with regard to other aspects, e.g. large density.

The body of the wheel weight is preferably built approximately rectangular or also round. In this connection, the surface facing the wheel is preferably configured somewhat arched to fit the rim at least to some extent in the installed state. The concave arching of this surface thus follows the curvature of a conventional motor vehicle rim of 17 inches to 19 inches diameter, for example. The surface in question can also be provided with a certain arch in the transverse direction.

Various means can serve to fasten the wheel weight to the wheel. It is possible to fasten the wheel weight consisting of ceramics to the rim similarly like a weight consisting of lead by means of adhesive tape, adhesive material or another adhesive means. For example, the ceramic weights can be delivered prefabricated on an adhesive tape. The adhesive tape is preferably attached to the arched surface of the wheel weight and has a certain thickness, one millimeter for example, and is preferably at least somewhat compressible. The adhesive tape can therefore compensate for different radii of curvature between the arched surface of the wheel weight and the corresponding fastening surface, which is formed by an inner circumferential surface of the rim for example.

It is also possible to provide a clamp as fastening

means. The clamp can be formed, for example, out of an existing shackle consisting of steel plate or another suitable material. The ceramic wheel weight preferably has a positive-locking means to hold the shackle and the wheel weight in tight spatial relationship to one another in the mounted state. E.g. a wheel weight can be provided with a projection that fits into a corresponding cutout of the fastening shackle. Conversely, the fastening shackle can also be provided with a projection that fits into a corresponding recess of the wheel weight. Corresponding projections and recesses are preferably thereby each configured approximately complimentary to one another. They furthermore preferably have a noncircular cross section, thereby preventing a twisting of the wheel weight relative to the shackle.

In a preferred embodiment, the surface of the wheel weight facing the wheel is provided with a compensation body that has a certain elastic or plastic flexibility. This compensation body can be made of latex foam, rubber, unvulcanized rubber, acryl, felt, or the like. The compensation body fills the gap forming between the wheel weight and the rim and, if it is dimensioned sufficiently flexible, can compensate for unequal gap widths and prevent rattling or slipping of the wheel weight. To this end, it can also be configured to improve the fit of the wheel weight on the rim by means of its static friction.

Other details are subject matter of claims, the drawing or the description. The drawing shows:

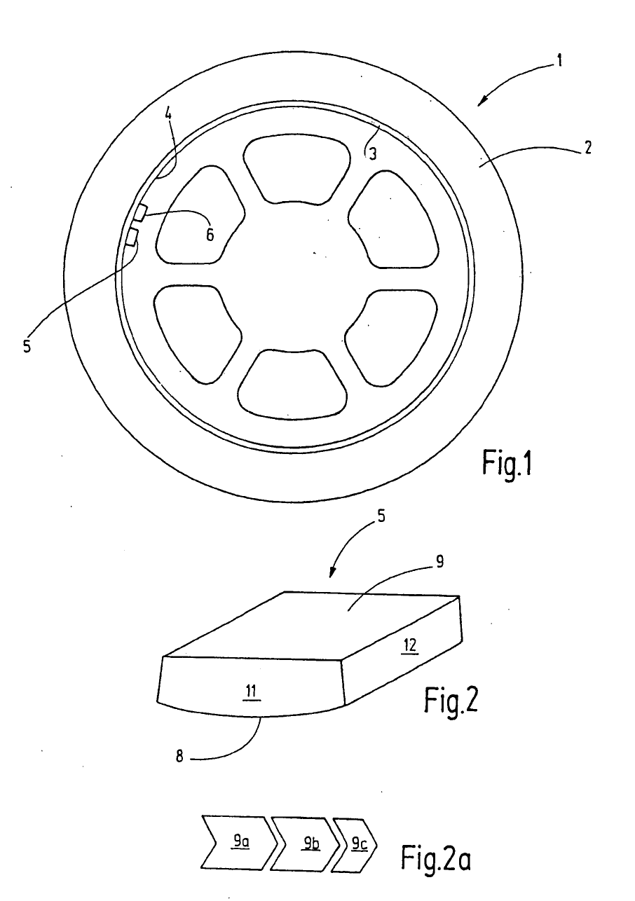

FIG. 1 a motor vehicle wheel with wheel weights mounted thereon;

FIG. 2 a wheel weight in a separate enlarged and perspective representation;

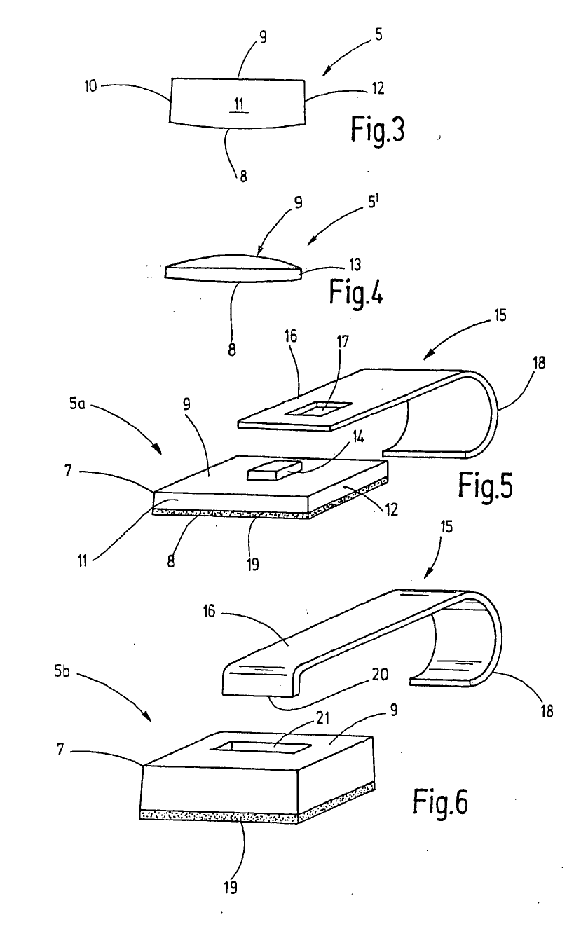

FIG. 3 a wheel weight in side view;

FIG. 4 a modified embodiment of a wheel weight in side view;

FIG. 5 a first embodiment of a wheel weight with fastening shackle in perspective exploded view and

FIG. 6 another embodiment of a wheel weight according to the invention with fastening shackle in exploded view.

FIG. 1 illustrates a motor vehicle wheel 1, which comprises a tire 2 and a rim 3 preferably consisting of metal.

The rim 3 has an inner circumferential surface 4, cylindrical for example, to which the one or more wheel weights 5, 6 are arranged. These serve to balance the motor vehicle wheel 1. They have identical or different shapes and weights. The wheel weight 5 will now be described in more detail below on behalf of both wheel weights 5, 6. This description accordingly applies to wheel weight 6, although it can differ in shape and size.

FIG. 2 illustrates the wheel weight 5 in perspective view, as evident it features an essentially rectangular body 7, which can be surrounded by six plane surfaces. But preferably at least one of the six surfaces is configured arched. In FIG. 2, this is the bottom surface 8, which in its installed state fits the inner circumferential surface of the rim 3. This surface 8 can be provided with an arch that coincides at least approximately with the arch of the inner circumferential surface 4. In this connection, a precise mathematical congruence does not matter. A slightly convex arching of the surface 8 is nevertheless viewed as advantageous in order to achieve an at least approximately extensive contact between the surface 8 and the inner circumferential surface 4.

For further explanation, we refer to FIG. 3, which likewise depicts the wheel weight 5. The surface 8 opposite upper surface 9 can be configured as a plane surface. It can also be shaped otherwise and be arched concave or convex for example. It moreover can be provided with elevated or indented reliefs, inscriptions, logos and the like.

The lateral surfaces 10, 11, 12 of the wheel weight 5 are preferably plane surfaces. They can transition into one another at straight or rounded edges. The lateral surfaces 10, 11, 12 are preferably arranged somewhat inclined against the surface 8 and/or the upper surfaces 9. The inclination angle can be, for example, one or a few degrees. In FIG. 2 it is depicted superelevated. Because of the stated inclination, the cross-sectional area of the body 5 continuously decreases from surface 8 to the upper surface 9. The body 5 is thus preferably a frustum of a pyramid with rectangular or quadratic base or a frustum of a cone with circular or elliptical base.

The upper surface 9 is preferably configured rectangular or quadratic. But it can also be configured circular, oval, hexagonal, pentagonal or otherwise. In particular, it is possible to provide arrow-shaped base and upper surfaces, as FIG. 2 illustrates in top view for a plurality of identically or differently sized wheel weights arranged in series with one another. The corresponding upper surfaces are labeled 9a, 9b, 9c. The single wheel weights can very easily be lined up a row, facilitating the alignment inside the row.

The upper surfaces 9 can be configured planar or, as shown in FIG. 4, concavely or convexly arched in one or more directions.

The bodies 7 of the wheel weights described above and below consist of ceramics, preferably a sintered ceramic. In principal, any suitable ceramic can be used in this connection, preferably this relates to an aluminum-oxide ceramic. This can also contain other metal oxides such as zirconium oxide for example. For production, a blank is produced out of a suitable base material of powdered nature or at least of powdered ingredients in the pressing process and then fired. The blank is preferably highly compressed so that the body 7 of the wheel weight 5 has a small volume with high weight.

To increase the weight, heavy ingredients, for example in the form of one or more compact ingredients or materials of high density existing as granular or powdered ingredients, can be worked into the body 7. The ceramic material of the body 7, for example, can contain barium compounds like barium oxide, barium sulfate (barite) or the like. The ceramic 7 preferably does not contain any ingredients that are hazardous to health or the environment like heavy metals or the like.

Unlike lead weights, the wheel weights 5, 6 consisting of ceramics are rigid and their geometric shape is precisely determined. During their production, they can be calibrated in regard to weight, e.g. before or after sintering. This can be accomplished by weighing and subsequent stripping, e.g. scraping, boring, milling, grinding or the like. This applies to all of the embodiments presented here, including the embodiment according to FIG. 4, which depicts an approximately lenticular wheel weight 5′ having a spherical upper surface 9 and round (approximately cylindrical, conical to be exact) lateral surface 13 extending all around.

The wheel weights 5, 6 can be fastened to the inner

circumferential surface 4 by gluing. Adhesive material can serve this purpose. It is also possible to use a double-sided adhesive tape for this or similar means that connect the surface 8 to the inner circumferential surface 4. Moreover, it is possible to fasten the wheel weights consisting of ceramics to the rim 3 with positive fit. FIG. 5 depicts an example. The wheel weight 5a depicted there largely corresponds to the wheel weight 5 according to FIG. 2 described above. Its surface 8 can be arched or, as illustrated, also be configured planar. A positive-locking means, e.g. in the form of a projection 14, can be arranged on the upper surface 9. These means can, as illustrated, be configured approximately rectangular, preferably shaped like the frustum of a pyramid to be precise. Like the lateral surfaces 11, 12 of the body 7, the lateral surfaces of the projection 14 can also be inclined slightly inwards. The front end of the projection 14 is again preferably planar or also rounded, e.g. configured curved spherically convex or the like.

The associated fastening shackle 15 consists of steel, for example. It has a clip 16, which can have an indentation or a window 17 to receive the projection 14. The contour of the window 17 preferably corresponds to the external contour of the projection 14, so that the latter locates into the window 17 with play or also with light clamping action. In the green state, the projection can have a length that is larger than the thickness of the clip 16. If the mass of the wheel weight is to be calibrated, it is possible to strip, e.g. grind off, the front of the projection somewhat before or after the firing of the body 7. Alternatively, the body 7 can be stripped at other locations before or after firing to adjust the desired mass.

The shackle 15 can have a singly or multiply bent end 18 that that serves for fastening to the rim 3.

A compensation body 19 is preferably fastened to the surface 8. The latter preferably coincides with the external contour of the body 7. It preferably has a certain flexibility to fit the inner circumferential surface 4 and compensate for any differences in curvature of the surfaces 8 and 4. The compensation body 19 can consist, for example, of non-vulcanized or slightly vulcanized rubber, felt, acryl, microcellular rubber or other plastically or elastically flexible materials. It can cover the surface 8 completely or partially and be configured strip-shaped or annular, for example. It provides for a rattle-free fit of the body 7 on the rim 3. E.g. the compensation body 19 can be bonded to the base 8. It can also be e.g. vulcanized on. The compensation body can be provided with adhesive material or sticking agent on its side facing the wheel. Alternatively, the surface facing the wheel can be free of adhesive means or sticking agents.

The above description of different embodiments of the wheel weight 5, especially the description of the embodiment according to FIG. 5, correspondingly applies to the wheel weight 5b according to FIG. 6. Further, we point out that the positive fit between the fastening shackle 15 and the wheel weight 5b is formed by a projection 20 of the clip 16 and a corresponding indentation or recess 21 in the wheel weight 5b. The projection 20 can be formed by a bent end of the fastening shackle 16. The indentation 21 can be a bag-like, hole-like or channel-like indentation which is arranged, for example, in the center of the upper surface 9 or also eccentrically within it. An optional compensation body 19 again serves

for fitting and improved contact of the wheel weight 5b on the rim 3.

The wheel weight 5 according to the invention consists of a body 7 consisting of ceramics. It is provided with means for fastening to a rim 3 with material fit and/or positive fit. The body 7 has a cross section that decreases along a prescribed direction, such as the direction normal to its upper surface 9. The ceramic body can have a high specific weight of two or more g/cm³ for example.

### REFERENCE CHARACTERS

1 Motor vehicle wheel
2 Tires
3 Rim
4 Inner circumferential surface
5 Wheel weight 5′, 5a
6 Wheel weight
7 Body
8 Surface
9 Upper surface (also 9a, 9b, 9c)
10 Lateral surface
11 Lateral surface
12 Lateral surface
13 Lateral surface
14 Projection
15 Fastening shackle
16 Clip
17 Window
18 End
19 Compensation body
20 Projection
21 Indentation

1. Wheel weight (5) for installation on a motor vehicle for balancing same,
having a rigid body (7), which has at least one fastening means,
characterized in that
the body (7) consists of a ceramic.

2. Wheel weight according to claim 1, characterized in that a surface (8) that faces the wheel in the fastened state has an arch.

3. Wheel weight according to claim 1, characterized in that the fastening means is a layer of adhesive material that is arranged on a surface (8) of the body (7).

4. Wheel weight according to claim 1, characterized in that the fastening means comprises a clamp (15).

5. Wheel weight according to claim 4, characterized in that an indentation (21) or a projection (14) is configured on one surface of the body (7) to form a positive-locking connection with the clamp (15).

6. Wheel weight according to claim 5, characterized in that the indentation (21) or the projection (14) have a noncircular cross section.

7. Wheel weight according to claim 1, characterized in that the body (7) is configured undercut-free and has a cross section that increases from one surface (9) to an opposite surface (8).

8. Wheel weight according to claim 1, characterized in that the body (7) consists of an aluminum-oxide ceramic.

9. Wheel weight according to claim 8, characterized in that the body (7) consists of a highly compressed sintered ceramic.

10. Wheel weight according to claim 1, characterized in that the body (7) is an isostatically pressed sintered body.
